(19) United States
(12) Patent Application Publication
(10) Pub. No.: US 2010/0169531 A1
(43) Pub. Date: Jul. 1, 2010

(54) INTELLECT STATION

(76) Inventor: Seok-Hee Bae, Seoul (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/090,374

(22) PCT Filed: Feb. 13, 2008
(86) PCT No.: PCT/KR08/00826

§ 371 Date: Apr. 16, 2008

(30) Foreign Application Priority Data
Feb. 14, 2007 (KR) 10-2007-0015441
Oct. 30, 2007 (KR) 10-2007-0109842
Jan. 31, 2008 (KR) 10-2008-0010363

(51) Int. Cl. G06F 13/00

(52) U.S. Cl. 710/303

(57) ABSTRACT

Disclosed herein is an intellect station which allows a laptop computer, an MP3 player, and/or a mobile phone to be placed thereon, wherein the intellect station includes a connection port set and a power supply unit that can be connected to an external port set and a power supply unit of the laptop computer, respectively, a speaker, a data storage device, including a hard disk drive, a flash memory set, and an optical storage device, such as a CD/DVD ROM drive, and a sensor for sensing wireless mouse, all of which are integrally mounted in the intellect station. According to the present invention, peripheral devices and cables of the laptop computer are neatly arranged, and therefore, the convenience of use is maximized.

### BACKGROUND OF THE INVENTION

1. Field of the Invention

The present invention relates to an intellect station which allows a laptop computer, an MP3 player, and/or a mobile phone to be placed thereon.

2. Description of the Related Art

Laptop computers, MP3 players, and mobile phones are generally recognized to be portable devices. For this reason, minimal research has been conducted into stations for the exclusive use of laptop computers, MP3 players, and/or mobile phones. When a user generally places a laptop computer on a desk to use the laptop computer, however, peripheral devices and cables of the laptop computer occupy the limited area of the desk, with the result that it is difficult and inconvenient for the user to place the laptop computer on the desk. Even when the user uses the laptop computer after placing the laptop computer on the desk, the peripheral devices of the laptop computer are disorganized, and therefore, the arrangement of the peripheral devices of the laptop computer is difficult and inconvenient. When the user uses the laptop computer on his/her lap, the user may feel discomfort due to heat generated from the laptop computer.

Also, a conventional computer table does not have a space enough to receive or dispose the peripheral devices and the cables of the laptop computer. As a result, the peripheral devices and the cables of the laptop computer are not neatly arranged, and therefore, a space necessary for the user to use the laptop computer is not sufficiently provided on the conventional computer table. Consequently, the use of the laptop computer is very inconvenient.

Also, the user may place an MP3 player or a mobile phone at a position adjacent to the laptop computer in order to listen to music through the MP3 player or the mobile phone or to answer the phone through the mobile phone during the use of the laptop computer. In this case, cables of the respective devices may be entangled, and the respective devices may drop to the floor. Furthermore, earphones are necessary for the user to listen to music stored in the MP3 player or the mobile phone, which is very inconvenient.

Meanwhile, various charging/speaker stations for MP3 players (including iPod) have been currently placed on the market. However, these charging/speaker stations are not products that are directly connected to the laptop computer, with the result that it is very inconvenient for the user to connect the charging/speaker stations to the laptop computer. Furthermore, the MP3 player additionally includes a charger for charging the MP3 player. Consequently, it is required for the user to use the charger in order to charge the MP3 player, which is very inconvenient.

The conventional computer table is constructed in a structure in which legs are integrally coupled to a top board, and a plurality of cables are connected to the laptop computer. For this reason, when the user works using the laptop computer on a sofa or a bed, it is difficult and inconvenient for the user to move the cables or mouse connected to the laptop computer.

Also, the conventional computer table does not have an additional device for preventing the occurrence of surge, with the result that, when the surge is applied to the computer table, all the devices connected to the computer table, as well as the computer table, may be out of order. Generally, as the integration degree of a semiconductor is increased, the line width of a circuit in the semiconductor is narrowed. Also, the semiconductor is made of a material exhibiting a high conductivity such that the semiconductor can be operated at a low voltage. Consequently, the maximum level of a short circuit phenomenon is decreased. As a result, a system including a large number of semiconductors is too weak to withstand the internal pressure thereof, and, such a system is proportionately affected by surge.

Also, when the user uses the laptop computer on a sofa or a bed, a shadow created by light emitted from a lamp hangs over a keyboard of the laptop computer depending upon a position where the user takes a seat, with the result that it is very difficult and inconvenient for the user to confirm characters on the respective keys of the keyboards.

### SUMMARY OF THE INVENTION

Therefore, the present invention has been made in view of the above problems, and it is an object of the present invention to provide an intellect station which allows a laptop computer to be placed thereon, wherein the intellect station includes a connection port set and a power supply unit that can be connected to an external port set and a power supply unit of the laptop computer, respectively, a speaker, a data storage device, including a hard disk drive, a flash memory set, and an optical storage device, such as a CD/DVD ROM drive, and a sensor for sensing a wireless mouse, all of which are integrally mounted in the intellect station.

It is another object of the present invention to provide an intellect station that allows peripheral devices of a laptop computer, an MP3 player, and/or a mobile phone to be conveniently placed and used and allows the laptop computer, the MP3 player, and/or the mobile phone to be easily charged, when using the laptop computer, the MP3 player, and/or the mobile phone.

It is another object of the present invention to provide an intellect station that is capable of reducing heat generated from the laptop computer.

It is another object of the present invention to provide an intellect station having an incline that is capable of making a user of the laptop computer maintain a correct posture, thereby preventing the occurrence of spinal injury, a crick in the shoulders, or neck injury.

It is another object of the present invention to provide an intellect station that is capable of allowing the user to use the laptop computer while the wrists of the user are little bent by the provision of a wrist rest formed at the lower end of the incline of the intellect station, thereby reducing wrist fatigue, wherein the wrist rest is constructed in a structure in which the height of the wrist rest can be easily adjusted by the user based on the body size and posture of the user.

It is another object of the present invention to provide an intellect station having a folding leg unit mounted at the bottom thereof to adjust the inclination angle of the intellect station such that the user can maintain his/her appropriate posture based on the physical conditions of the user and the place where the laptop computer is used, such as a sofa or a bed.

It is another object of the present invention to provide an intellect station constructed in a structure in which the laptop computer is placed on the ergonomically-designed incline of the intellect station such that a keyboard of the laptop computer is inclined, and therefore, the bending degree of the wrists is decreased during the input work using the keyboard, thereby reducing wrist fatigue.

It is another object of the present invention to provide an intellect station constructed in a structure in which a mouse is placed on a mouse pad incline having an inclination angle less than the inclination angle of the ergonomically-designed incline of the intellect station, such that the bending degree of the wrists is decreased without the down-sliding of the mouse during the use of the mouse, thereby reducing wrist fatigue.

It is another object of the present invention to provide an intellect station that is capable of providing quality sound to the user of the laptop computer by reinforcing sound output from the laptop computer and of allowing the user to listen to music or sound through a speaker by amplifying a sound source stored in the MP3 player and/or the mobile phone.

It is another object of the present invention to provide an intellect station that is capable of preventing the eyes of the user from feeling fatigue due to a shadow created on the keyboard of the laptop computer anywhere the user uses the laptop computer by the provision of a lamp.

It is another object of the present invention to provide an intellect station adopting a wireless universal serial bus (USB) that allows peripheral devices be conveniently placed and used without the use of cables for connection between the laptop computer and the intellect station.

It is another object of the present invention to provide an intellect station adopting an automatic cable rewinding device using a leaf spring that allows power cables to be easily arranged.

It is another object of the present invention to provide an intellect station that is capable of automatically stopping the function of an amplifier, when no voice signal is inputted to the intellect station, thereby effectively preventing a signal sound occasionally generated during word processing from being outputted through speakers.

It is a further object of the present invention to provide an intellect station constructed in a structure in which a laptop computer power adaptor cable disposed in a rear storage box of the intellect station is connected to a laptop computer through a channel defined in a top storage box of the intellect station, thereby achieving convenient cable connection.

In accordance with the present invention, the above and other objects can be accomplished by the provision of an intellect station including a connection port set and a power supply unit connected to an external port set and a power supply unit of a laptop computer, and at least one data storage unit selected from a group consisting of storage units, such as a hard disk drive and a flash memory set, and an optical storage unit, such as a CD/DVD ROM drive, wherein a wrist rest is detachably mounted at the lower end of an incline of the intellect station, and at least one speaker is mounted in an inclined protrusion protruding from the upper end of the incline or either side of the inclined protrusion. A small-sized microphone mounted in the wrist rest or inside the incline below the wrist rest such that communication can be carried out without using a headset during voice chatting. One or more fan grills are formed at the center of the incline for dissipating heat generated from the laptop computer. One or more fans are mounted in the fan grills.

Also, the intellect station is provided at the upper end of the incline thereof with at least one selected from a group consisting of an MP3 player or mobile phone charging power port, a universal serial bus (USB) port, a speaker connection port set, an intellect station power switch, a fan power/speed control switch, an audio power/volume switch, and a microphone power switch. The intellect station is provided at one side thereof with a port set including at least one selected from a group consisting of a microphone connection port, a speaker connection port, an amplifier power switch and, an intellect station power switch. At least one selected from a group consisting of the microphone power switch, the USB port, the audio power/volume switch, and fan power/speed control switch, which are mounted the upper end of the incline, may be included in the port set mounted at the side of the intellect station.

Meanwhile, the microphone connection port, the speaker connection port, the USB port, and the power port may be manufactured in the form of a docking connector port having a plurality of pins such that a docking station connection port of the laptop computer or various ports of the laptop computer can be more easily connected to external devices or ports through the single docking connector port.

Also, the intellect station may be provided at one side thereof with a power supply port for connection with a lamp device for illumination. A power port of the lamp device is connected to power supply port of the intellect station.

Also, a mouse board may be mounted in the intellect station, such that the mouse board can be withdrawn from the intellect station from one side of the intellect station, if necessary, in order to use a mouse on the mouse board.

In the intellect station is also mounted a storage unit, such as a hard disk drive or a flash memory set, which is utilized as an auxiliary storage unit of the laptop computer. The storage unit is used as an automatic data backup device when the laptop computer is lost or a hard disk of the laptop computer is out of order.

In the intellect station is also mounted an optical storage unit, such as a CD/DVD ROM drive, for allowing a user to conveniently listen to music, watch motion pictures, and install programs.

Also, the intellect station may be provided with a simple-structure display unit, for example, a liquid crystal display (LCD) or a light emitting diode (LED), which is used to monitor the port connection state or the operation state of various cables.

Preferably, the intellect station is provided at the rear thereof with a receiving space for receiving a hard disk. In the receiving space is formed a receiving part for receiving an input and output port, including a USB port, a power adaptor of the laptop computer and a plurality of power cables. The receiving part has an alternating current (AC) outlet, which is connected to the power supply unit for supplying power to the power supply unit, mounted therein. Also, the intellect station further includes air circulating grills disposed at opposite sides of the receiving part for circulating air. Meanwhile, output ports to external devices or ports corresponding to the port set disposed at one side of the intellect station or the docking connector may be disposed at the receiving part formed at the rear of the intellect station.

Meanwhile, the intellect station may be provided at one side thereof with a cable rewinding switch to drive an automatic cable rewinding device for automatically rewinding the power cable of the intellect station using a leaf spring such that the power cable of the intellect station is received in the intellect station, whereby the arrangement of the cable is simplified.

A folding leg unit or a height adjustment lever may be mounted at the bottom of the intellect station to adjust the inclination angle and the height of the intellect station. When the intellect station is used while the intellect station is placed on a table, the leg unit is folded. When the intellect station is used while a user sits on a bed or a sofa, on the other hand, the heights of the front and rear of the intellect station may be adjusted based on the physical conditions and posture of the user such that the inclination angle of the intellect station as well as the height of the intellect station can be adjusted.

Meanwhile, the intellect station directly interfaces with a laptop computer via a single USB port through the use of a USB hub constructed to process a signal from an audio signal processor, an external numeric keypad, a hard disk storage device or a solid state drive (SSD), and a wireless mouse receiver.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating an intellect station according to a preferred embodiment of the present invention;

FIG. 2 is a side view of the intellect station shown in FIG. 1;

FIG. 3 is a partially enlarged view of the intellect station shown in FIG. 1;

FIG. 4 is a block diagram illustrating the connection between a laptop computer, an MP3 player, and a mobile phone through the intellect station shown in FIG. 1;

FIG. 5 is a perspective view illustrating the rear of the intellect station shown in FIG. 1;

FIG. 6 is a sectional view illustrating a docking connector;

FIG. 7 is a constructional view illustrating the connection between the laptop computer and the intellect station through the docking connector shown in FIG. 6;

FIG. 8 is a constructional view illustrating the connection between the laptop computer and a port set of the intellect station using the docking connector according to the present invention;

FIG. 9 is a constructional view illustrating the wireless connection between the laptop computer, the MP3 player, and the mobile phone using Blue tooth according to the present invention;

FIG. 10 is a flow chart illustrating an automatic data backup;

FIG. 11 is a constructional view illustrating a folding leg unit mounted at the bottom of the intellect station according to the present invention;

FIG. 12 is a constructional view illustrating unfolding of the folding leg unit shown in FIG. 11 to adjust the height of the folding leg unit;

FIG. 13 is a constructional view illustrating unfolding of a height adjustment lever shown in FIG. 11;

FIGS. 14 to 16 are side views of the intellect station according to the present invention, illustrating the adjustment of the height of the height adjustment lever shown in FIG. 13;

FIG. 17 is a block diagram illustrating the connection between the laptop computer, the MP3 player, and the mobile phone when using a sound chip;

FIG. 18 is a block diagram illustrating the wireless connection between the laptop computer and the intellect station using a wireless USB, as another embodiment of FIG. 17; and

FIG. 19 is a block diagram illustrating another embodiment of the intellect station according to the present invention.

### DESCRIPTION OF THE PREFERRED EMBODIMENTS

Now, preferred embodiments of the present invention will be described in detail with reference to the accompanying drawings.

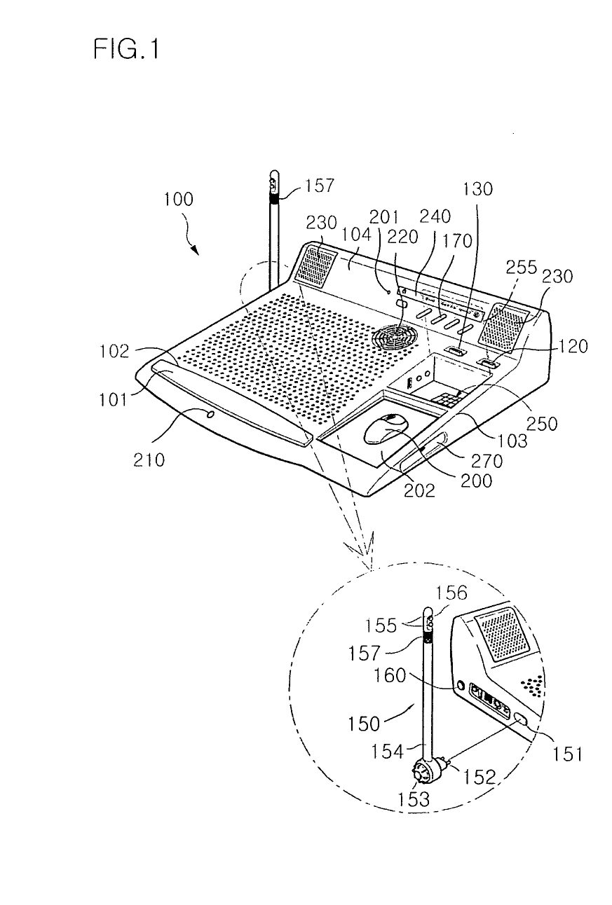

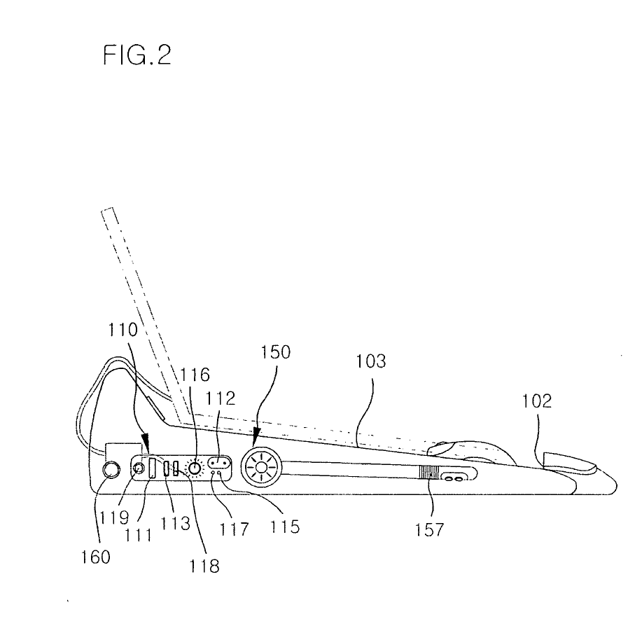

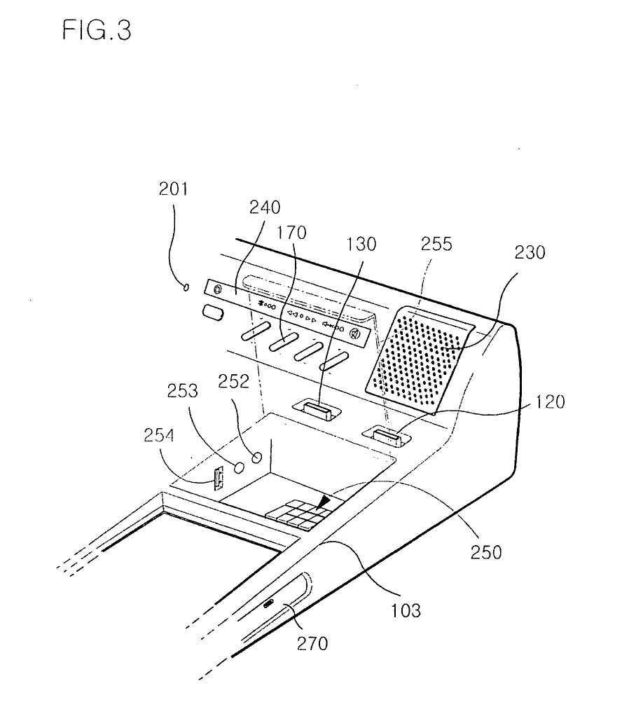

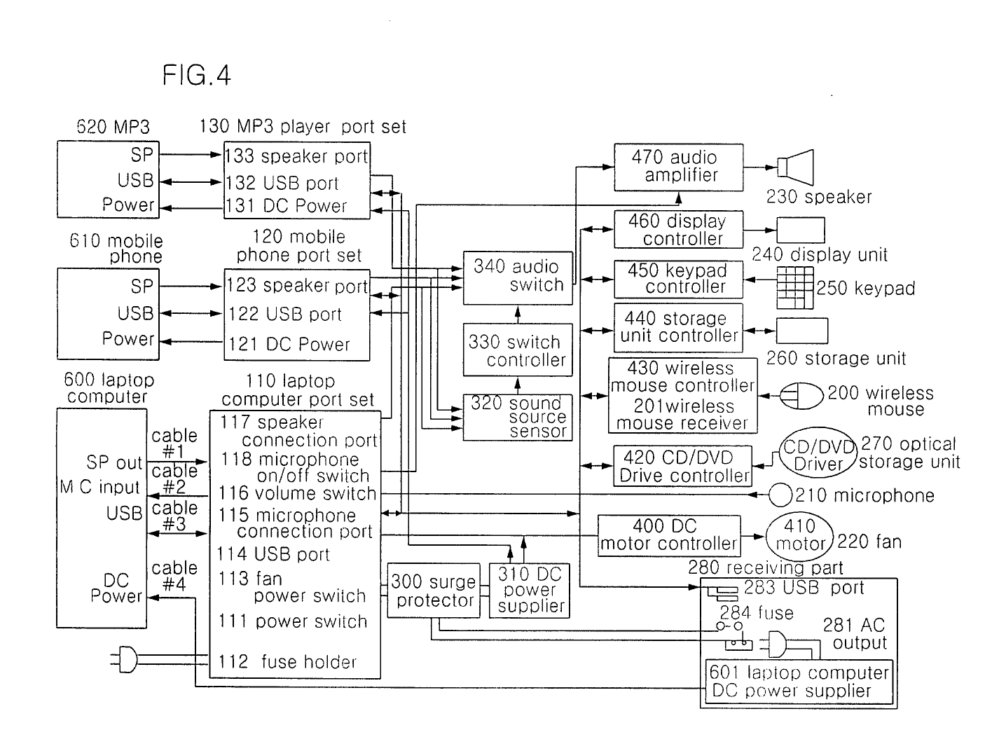

FIG. 1 is a perspective view illustrating an intellect station 100 according to a preferred embodiment of the present invention, FIG. 2 is a side view of the intellect station 100 shown in FIG. 1, FIG. 3 is a partially enlarged view of the intellect station 100 shown in FIG. 1, and FIG. 4 is a block diagram illustrating the connection between a laptop computer, an MP3 player, and a mobile phone through the intellect station 100 shown in FIG. 1.

Referring to FIGS. 1 to 3, the intellect station 100 has an incline 103. At the lower end of the incline 103 is formed a wrist rest 101, which protrudes from the incline 103. A microphone 210 is mounted in the wrist rest 101 or inside the incline 103 below the wrist rest 101. The wrist rest 101 protrudes upward from the incline 103. At the upper end of the wrist rest 101 is formed a stopping protrusion 102 for preventing the laptop computer from slipping along the incline 103. At the upper end of the incline 103 is formed an inclined protrusion 104, in which a plurality of speakers 230 are mounted. Alternatively, the speakers 230 may be mounted at opposite sides of the inclined protrusion 104.

Preferably, the wrist rest 101 is constructed such that wrists of a user are brought into tight contact with the wrist rest 101, and therefore, the user can use a keyboard of the laptop computer in a comfortable posture for a long period of time. The shape of the wrist rest 101 may be variously changed depending upon the physical conditions of users. More preferably, the wrist rest 101 is constructed in a structure in which the wrist rest 101 can be detachably mounted to the lower end of the incline 103 and the height of the wrist rest 101 can be easily adjusted by the user based on the body size and posture of the user.

Also preferably, the incline 103, the inclined protrusion 104, and/or the wrist rest 101 of the intellect station 100 are integrally formed of a plastic material, by which the manufacturing costs and the assembly costs of the intellect station 100 are reduced.

At the incline 103 of the intellect station 100 are formed one or more fan grills, under which one or more fans 220 are mounted. Consequently, when the laptop computer is placed on the intellect station 100, the laptop computer is cooled by the one or more fans 220, and therefore, heat generated from the laptop computer 600 is reduced. The number and the position of the fans may be variously changed depending upon the size and the volume of laptop computers placed on the intellect station 100.

The one or more speakers 230, mounted in the inclined protrusion 104, formed at the upper end of the incline 103, or at the opposite sides of the inclined protrusion 104, are driven by an audio amplifier 470, which is mounted inside the inclined protrusion 104. Also, the speakers 230 receive an audio signal through a speaker port of the laptop computer, which is one of the components constituting the external port set, to output audio. Preferably, the speakers 230 are mounted at positions opposite to the user of the laptop table. According to circumstances, the speakers 230 may be mounted at the opposite sides of the inclined protrusion 104.

The microphone 210 is mounted at a predetermined position inside the incline 103 of the intellect station 100 for receiving an external voice, especially, a voice of the user of the laptop computer. The position of the microphone 210 is not limited so long as the external voice can be received into the microphone 210. Preferably, however, the microphone 210 is located at the middle of the lower end of the incline 103 of the intellect station 100 in consideration of the work position of the user. Generally, the user works, while there is a distance between both hands of the user, during the use of the laptop computer. Consequently, it is preferable to locate the microphone 210 between the both hands of the user, i.e., at the middle of the wrist rest 101, formed at the lower end of the incline 103, or at the middle of the incline 103 below the wrist rest 101.

At the incline 103 of the intellect station 100 may be mounted a mouse pad 202, by which the abnormal operation of a mouse, such as an optical mouse, is prevented, and the sensibility of the mouse is improved. The mouse pad 202 may be detachably attached to the incline 103 of the intellect station 100. According to circumstances, a mouse board may be mounted in the intellect station 100, such that the mouse board can be withdrawn from the intellect station 100 from one side of the intellect station 100, if necessary, in order to secure a large space on the incline 103.

Also, the detachable mouse pad 202 may be mounted at the incline 103 of the intellect station 100 such that the user can use a mouse 200 on the mouse pad 202. In addition, a numeric keypad 251 may be mounted at the incline 103 of the intellect station 100. Preferably, a depression is formed at a predetermined position of the incline 103 to define a space where the mouse pad 202 is mounted such that the mouse 200 is prevented from being separated from the incline 103. Also, a depression is formed at a predetermined position of the incline 103 to define a surface receiving part 250, in which the numeric keypad 251 is mounted. Consequently, the numeric keypad 251, which is not frequently used, does not protrude outward, and therefore, any inconvenience to the user due to the numeric keypad 251 is prevented. Especially, a cover 255 is mounted at the incline 103 above the surface receiving part 250, in which the numeric keypad 251 is mounted, such that the cover 255 can be opened from the lower end to the upper end of the incline 103 by hinge members. Consequently, it is possible for the user to close the surface receiving part 250 using the cover 255, when the numeric keypad 251 is not used, whereby more space on the incline 103 is secured, and therefore, the convenience of the user is improved. In an example of the intellect station 100, the numeric keypad 251 may not be mounted at the incline in order to reduce the area of the incline 103. In this case, some functions of the intellect station 100 may be omitted.

As shown in the drawings, the numeric keypad 251 is mounted at the upper right side of the incline 103. For the convenience of the user, on the other hand, the numeric keypad 251 may be mounted at the upper left side of the incline 103. Generally, most laptop computers do not include a numeric keypad including numeric keys from 0 to 9 and several functional keys, such as an enter key, except some large-sized laptop computers. When the numeric keypad 251 is used for a spread sheet or a calculation, however, work efficiency is greatly improved. The numeric keypad 251 is connected to the laptop computer through a universal serial bus (USB) port mounted in the intellect station 100. The numeric keypad 251 is mounted at a predetermined position of the intellect station 100 where the user can easily and conveniently use the numeric keypad 251, for example, the left side part or the right side part of the incline 103 of the intellect station 100, in the form of a module. The numeric keypad 251 may be covered by the numeric keypad cover such that the numeric keypad 251 can be appropriately protected when not in use. When the numeric keypad 251 is used, the numeric keypad cover is removed, and, when the numeric keypad 251 is not used, the numeric keypad 251 is covered by the numeric keypad cover. Consequently, the convenience of use is improved.

As shown in FIG. 2, the intellect station 100 is provided at one side thereof with a module-type port set 110 including various ports and a power supply unit.

Specifically, the port set 110 includes a power switch 111 for turning the intellect station 100 on and off, a USB port 114 necessary to connect the laptop computer with various peripheral devices in a USB connection fashion, a microphone connection port 115 for inputting a voice to the laptop computer, a speaker connection port 117 for outputting a voice from the laptop computer to external speakers, an audio volume switch 116 connected to the speaker connection port 117 for adjusting the sound volume of the outputted voice, a fan power/speed control switch 113 for driving the cooling fans mounted in the intellect station 100, a microphone on/off switch 118, and a fuse holder 112, which are selectively manufactured in the form of a module as occasion demands.

Among the above-mentioned switches, the fan power/speed control switch 113, the audio volume switch 116, and the microphone on/off switch 118, which are frequently used by the user, may be mounted at one side of the upper end of the incline 103 in the form of a switch unit 170 such that the user can easily find the fan power/speed control switch 113, the audio volume switch 116, and the microphone on/off switch 118.

In addition, the intellect station 100 is provided at one side thereof with a power supply port 151, to which a lamp device 150 for illumination is coupled. Specifically, a power port 152 of the lamp device 150 is connected to the power supply port 151 such that power necessary to drive the lamp device 150 is supplied to the lamp device 150. The lamp device 150 is provided at the side opposite to the power port 152 with a rotary roller 153 for rotating a rotary rod 154. The rotary rod 154 has a space defined therein. A power supply cable is connected to lamps 155, mounted to one end of the rotary rod 154, through the space of the rotary rod 154 such that power for driving the lamps 155 is supplied to the lamps 155. Small-sized halogen lamps may be used as the lamps 155; however, light emitting diodes (LEDs) are preferably used as the lamps 155. At the end of the rotary rod 154 is formed a groove 156, in which the lamps 155 are mounted such that the lamps 155 do not protrude outward beyond the surface of the rotary rod 154. The number of the lamps 155 mounted in the groove 156 is not particularly restricted. Preferably, however, two lamps 155 are arranged such that the lamps 155 are spaced a predetermined distance from each other. The rotary rod 154 preferably has a length less than that of the incline 103 such that the rotary rod 154 does not protrude outward beyond the incline 103 when the rotary rod 154 is placed in parallel with the intellect station 100. At the end of the rotary rod 154 is formed a bending member 157, which is constructed in the form of an elastic bellows. Consequently, the bending member 157 may be bent toward the keyboard of the laptop computer, after the rotary rod 154 is erected, such that the keyboard is illuminated by light emitted from the lamps 155.

On the other hand, the intellect station 100 may be provided at one side thereof with a cable rewinding switch 160 to drive an automatic cable rewinding device for automatically rewinding the power cable of the intellect station 100 using a leaf spring such that the power cable of the intellect station 100 is received in the intellect station 100. In this case, the arrangement of the cable is simplified.

Also, a display unit 240 may be disposed at a predetermined position of the inclined protrusion 104 of the intellect station 100. For example, a small-sized LCD or a plurality of LEDs are mounted at the inclined protrusion 104 to monitor the connection or the operation of the above-described port set or connector.

Specifically, power on/off, kind and operation state of the port connected, and the level of sound volume are displayed. In addition, other simple functions, such as a clock function, may be realized. Voltage or current at which the respective ports are connected is detected, the level of the detected voltage or current is measured to light the LEDs, or predetermined characters or images are displayed on the LCD. This display technology is well known in the art to which the present invention pertains, and therefore, a detailed description thereof will not be given.

FIG. 3 is an enlarged view illustrating an MP3 player port set 130, a mobile phone port set 120, and the surface receiving part 250 of the intellect station 100 shown in FIG. 1. Depressions are formed around the port sets such that the port sets protrude outward in the corresponding depressions. The MP3 player port set 130 preferably includes a speaker port 133, a USB port 132, and a power supply port 131, through which an MP3 player 620 interfaces with the intellect station 100 such that data (a voice and a control signal) is transmitted between the MP3 player and the intellect station 100. The mobile phone port set 120 preferably includes a speaker port 123, a USB port 122, and a power supply port 121, through which a mobile phone 610 interfaces with the intellect station 100 such that data (a voice and a control signal) is transmitted between the mobile phone and the intellect station 100.

In addition, a USB port 254, a speaker port 252, and a microphone port 253 are mounted in the surface receiving part 250, in which the numeric keypad 251 is mounted. The connection to the USB port 254 in the surface receiving part 250 is required to use the numeric keypad 251.

On the other hand, when the laptop computer includes a USB connection port, a speaker connection port, and a microphone connection port mounted at the right side thereof, the USB connection port, the speaker connection port, and the microphone connection port of the laptop computer are more conveniently connected to the USB port 254, the speaker port 252, and the microphone port 253 in the surface receiving part 250 than to the USB port, the speaker port, and the microphone port in the port set 130 or 120 because it is possible to use USB, speaker, and microphone cables having a relatively small length. When the numeric keypad 251 is not mounted in the surface receiving part 250, peripheral devices, such as a USB memory and a wireless mouse body, may be received in the surface receiving part 250, whereby the peripheral devices of the laptop computer are neatly arranged, and therefore, the use of the laptop computer is more convenient.

FIG. 4 is a block diagram illustrating the intellect station 100 according to the present invention. As shown in FIG. 4, the port set 110 includes the speaker connection port 117 for receiving an audio signal transmitted from the laptop computer 600, the audio volume switch 116, the microphone connection port 115, the USB port 114, the fan power/speed control switch 113, the power switch 111, and the fuse holder 112. The speaker output port (SP out) of the laptop computer 600 is connected to the speaker connection port 117 of the port set 110 via Cable #1. The microphone port (MIC input) of the laptop computer 600 is connected to the microphone connection port 115 of the port set 110 via Cable #2. The USB port of the laptop computer 600 is connected to the USB port 114 of the port set 110 via Cable #3. The microphone connection port 115 of the port set 110 is connected to the microphone 210 for audio input.

Also, the intellect station 100 further includes a surge protector 300 for clamping excessive voltage, when surge is introduced into voltage supplied to the intellect station 100 due to thunder and lightning, to protect various electronic components of the intellect station 100 and the laptop computer 600 connected to the intellect station 100 from the surge, a direct current (DC) power supply unit 310 including a rectifier for rectifying alternating current (AC) voltage of 110 to 220 V, supplied through the surge protector 300, into a DC voltage and a transformer for transforming the DC voltage, rectified by the rectifier, into a predetermined DC voltage, such as DC 5V, DC 12V, or DC 16V, an audio amplifier 470 for amplifying audio outputted from the speaker connection port 117 of the port set 100, which is connected to the speaker output port (SP out) of the laptop computer 600, to a predetermined level, and left and right speakers 230 for transmitting the audio, amplified by the audio amplifier 470, to the outside.

Also, the intellect station 100 further includes a display controller 460 connected to the port set 110 for generating a control signal for display, a display unit 240 connected to the display controller 540 for displaying functions and data on the screen, a numeric keypad 251 for inputting numbers and function signals, and a keypad controller 450 for receiving and processing the function signals inputted from the numeric keypad 251.

Also, the intellect station 100 further includes a storage unit 260 for storing a program and data, a storage unit controller 440 connected to the storage unit 260 for processing the program stored in the storage unit 260 and processing and storing the data in the storage unit 260, a wireless mouse 200, and a wireless mouse controller 430 including a wireless mouse receiver for receiving and processing the signal transmitted from the wireless mouse 200.

Generally, a wire mouse may be directly connected to the USB port of the laptop computer, and therefore, a detailed description of the wire mouse will not be given. When the wireless mouse controller 430, the wireless mouse receiver 201, and the 27 MHz wireless mouse 200, which are connected to the USB port in the intellect station 100, are used, on the other hand, a convenient computing environment without a mouse cable may be constructed. The storage unit 260 means a hard disk drive (HDD) or a large-capacity USB memory, such as a large-capacity flash memory.

In addition, the intellect station 100 is provided at one side thereof with an optical storage unit 270, such as a CD/DVD ROM drive. In this connection, the intellect station 100 further includes a CD/DVD ROM drive controller 420 for processing a program and data stored in the optical storage unit 270 or storing music and image data, and a motor controller 400 connected to the fan power/speed control switch 113 of the port set 110 for controlling motors 410, which drive the fans 220.

When a central processing unit (CPU) of the laptop computer is overloaded or the temperature of the intellect station 100, on which the laptop computer is placed, is increased due to high outdoor temperature, as in the summer season, or radiant heat from the laptop computer, the motor controller 400 transmits a drive signal to the motors such that the fans are operated by the motors if the temperature detected by a temperature sensor mounted at one side of each fan grill is higher than a reference temperature level. In order to reduce the noise generated from the fans, the number of rotations of the motors may be limited based on the temperature detected by the temperature sensors. Alternatively, the shape or the number of the fans may be adjusted to control the noise generated from the fans depending upon the amount of blown air.

Also, the intellect station 100 further includes the MP3 player port set 130, through which the MP3 player 620 interfaces with the intellect station 100 such that data (a voice and a control signal) is transmitted between the MP3 player 620 and the intellect station 100, and the mobile phone port set 120, through which the mobile phone 610 interfaces with the intellect station 100 such that data (a voice and a control signal) is transmitted between the mobile phone 610 and the intellect station 100. The MP3 player port set 130 includes the speaker port 133, which is connected to the speaker port (SP) of the MP3 player 620, the USB port 132, which is connected to the USB port (USB) of the MP3 player 620, and the power supply port 131, through which power is supplied to the power port (power) of the MP3 player 620. The mobile phone port set 120 includes the speaker port 123, which is connected to the speaker port (SP) of the mobile phone 610, the USB port 122, which is connected to the USB port (USB) of the mobile phone 610, and the power supply port 121, through which power is supplied to the power port (power) of the mobile phone 610.

Also, the intellect station 100 further includes a sound source sensor 320 connected to output lines of the speaker connection port 117 of the laptop computer port set 110, the speaker port 133 of the MP3 player port set 130, and the speaker port 123 of the mobile phone port set 120 for detecting which output line the sound source exists on, a switch controller 330 for analyzing the signal detected by the sound source sensor 320 to determine which output line the sound source exists on, and controlling the switch to output the sound source from the corresponding output line to the audio amplifier 470, and an audio switch 340 for selecting only one of the output lines of the speaker connection port 117 of the laptop computer port set 110, the speaker port 133 of the MP3 player port set 130, and the speaker port 123 of the mobile phone port set 120 in response to the control of the switch controller 330, and transmitting the sound source from the selected output line to the audio amplifier 470.

Also, the intellect station 100 further includes a USB port 283 for data communication, a fuse holder 284 for holding a fuse to intercept overvoltage, a power outlet 281, a DC power supply unit 601 for supplying power to the laptop computer 600, and a receiving part 280 for receiving various peripheral devices of the laptop computer.

At the rear of the intellect station 100 is hingedly mounted a cover 282 for covering the receiving part 280. At the rear of the intellect station 100, on opposite sides of the receiving part 280, are formed fan grills through which air circulated by the fans 220 mounted inside the incline 103 is introduced into or discharged from the intellect station 100.

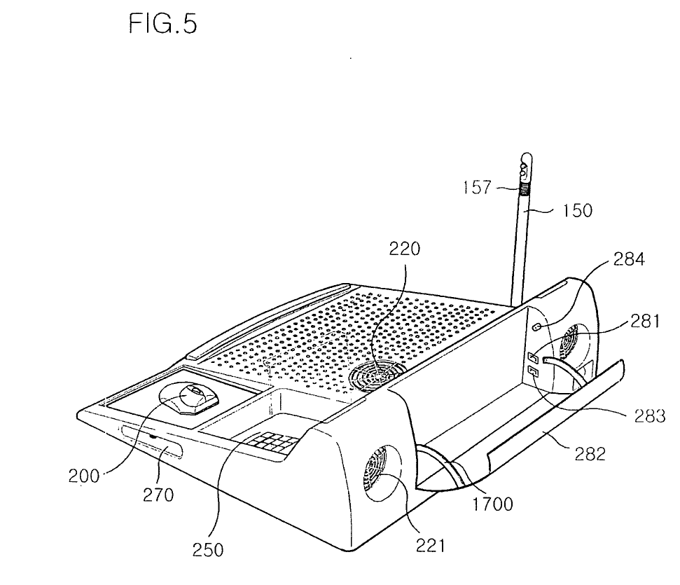

FIG. 5 is a perspective view illustrating the rear of the intellect station 100 according to the present invention. As shown in FIG. 5, the receiving part 280, for receiving a power cable and an AC adaptor of the laptop computer 600, is formed at the rear of the intellect station 100. The power outlet 281, for connecting the power cable of the laptop computer 600 to the power port of the port set 110, is mounted in the receiving part 280.

Meanwhile, output ports corresponding to the port set or a docking connector may be disposed at the rear of the intellect station 100. The output ports receive signals from the laptop computer through the port set of the intellect station or the docking connector and output the received signals to external devices, for example, various USB-type peripheral devices. Through the above-described construction, the user of the laptop computer can easily and conveniently connect the laptop computer with various external devices.

In a receiving space defined in the receiving part 280 may be received various external small-sized devices (for example, a hard disk) connectable through the USB port for the laptop computer or the like.

The various devices received in the receiving part 280 may be supplied with power through the power outlet 281 disposed in the receiving part 280 or the USB port 283 in the receiving space. The power outlet 281 may be electrically connected to the port unit 110 such that the power outlet 281 can receive power from the port unit 110.

A connection channel is formed between the receiving part 280 and the surface receiving part 250 such that the power cable extending from the DC power supply unit 601, which is mounted in the receiving part 280, can be connected to the laptop computer through the hole of the receiving part 280 or the side hole of the surface receiving part 250.

A storage unit 260, such as a hard disk drive and a flash memory set, is mounted in the intellect station 100. Furthermore, an optical storage unit 270, such as a CD/DVD ROM drive, is mounted in the intellect station 100. Consequently, it is possible for the user to conveniently listen to music, watch motion pictures, and install programs.

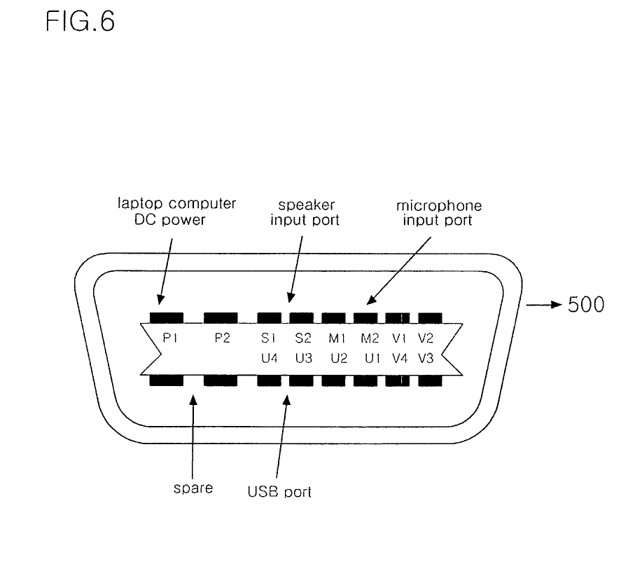

FIG. 6 illustrates a docking connector 500. Various ports, included in the port set provided at the intellect station 100 as described above, may be manufactured in the form of a single docking connector, which is mounted in the intellect station 100.

Also, the docking connector 500 may be fixed to the intellect station 100 such that the docking connector 500 can be connected to docking connector connection ports of the laptop computer. Alternatively, the docking connector 500 may be withdrawn from the intellect station 100 such that the docking connector 500 can be directly connected to the docking connector connection ports of the laptop computer.

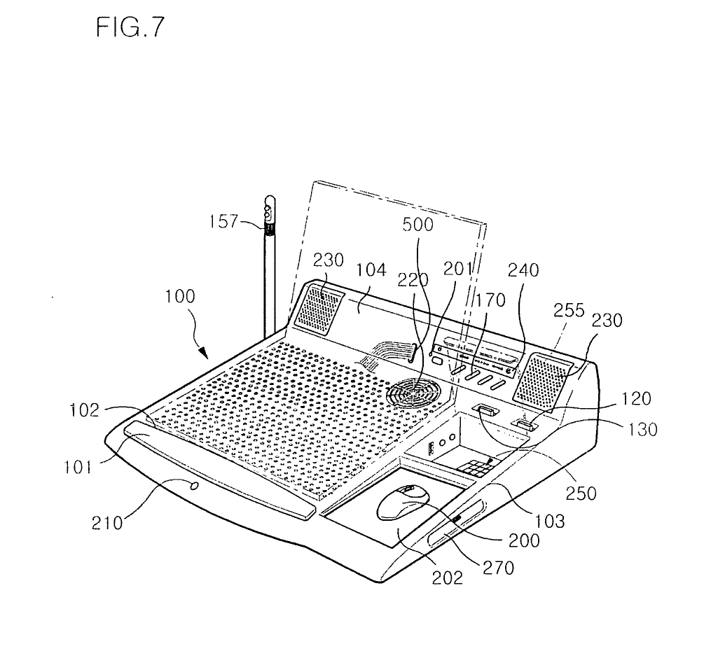

As shown in FIG. 7, for example, a slot-type docking connector connection port, which transmits and receives various kinds of data and control signals to and from the laptop computer through a plurality of pins and supplies power to the laptop computer, is provided at one side of the intellect station 100. The slot-type docking connector connection port is either connected to the docking connector 500 disposed at one side part of the intellect station 100 or is connected to the respective ports via additional cables. Consequently, the laptop computer can be connected to either the output ports of the receiving part disposed at the rear of the intellect station 100 or external devices. The functions of the respective pins of the docking connector may be optionally decided by manufacturing companies depending upon kinds of products to be connected. The construction of the connector and the cable for interconnecting the connector of the intellect station 100 and the connector of the laptop computer is well known in the art to which the present invention pertains, and therefore, a detailed description thereof will not be given.

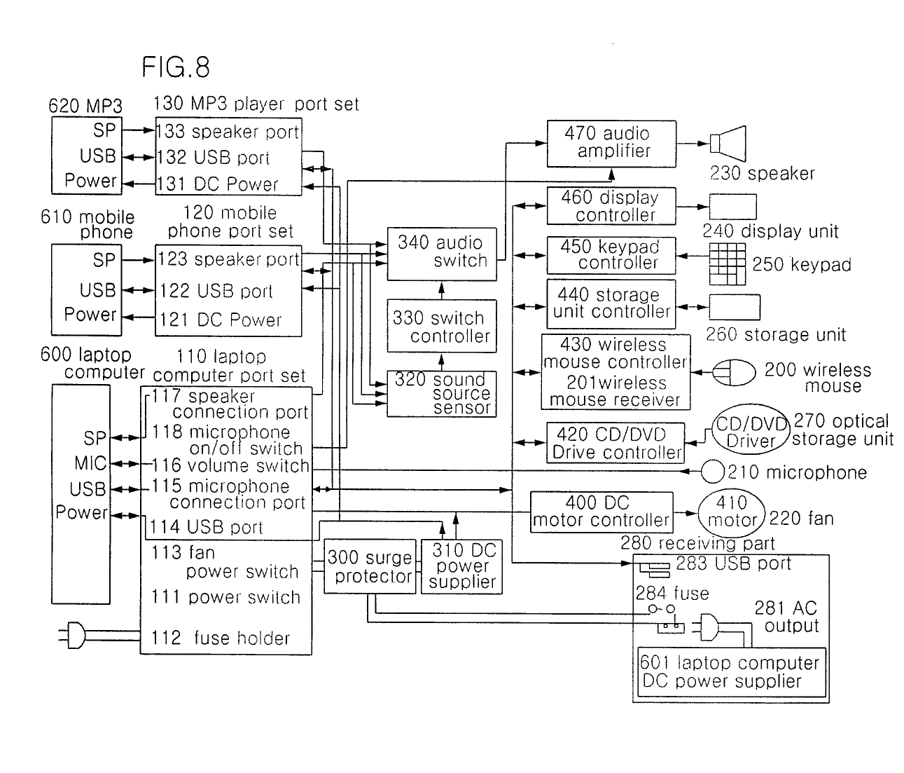

FIG. 8 is a constructional view illustrating the connection between the port set 110 and the laptop computer 600 using the docking connector 500. As compared to FIG. 4, it can be seen that the speaker connection port 117, the microphone connection port 115, and the USB port 114 of the port set 110 and the connection port for supplying power from the DC power supply unit 310 of the intellect station 100 to the laptop computer are connected to a single connector.

The speaker/amplifier port, the microphone port, the USB port, and the video input port of the port set 110 are connected to the laptop computer 600 via the single docking connector 500. Furthermore, power is supplied from the power supply unit of the intellect station 100 to the laptop computer via the docking connector 500. Consequently, the intellect station 10 according to the present invention can be more conveniently used for the laptop computer.

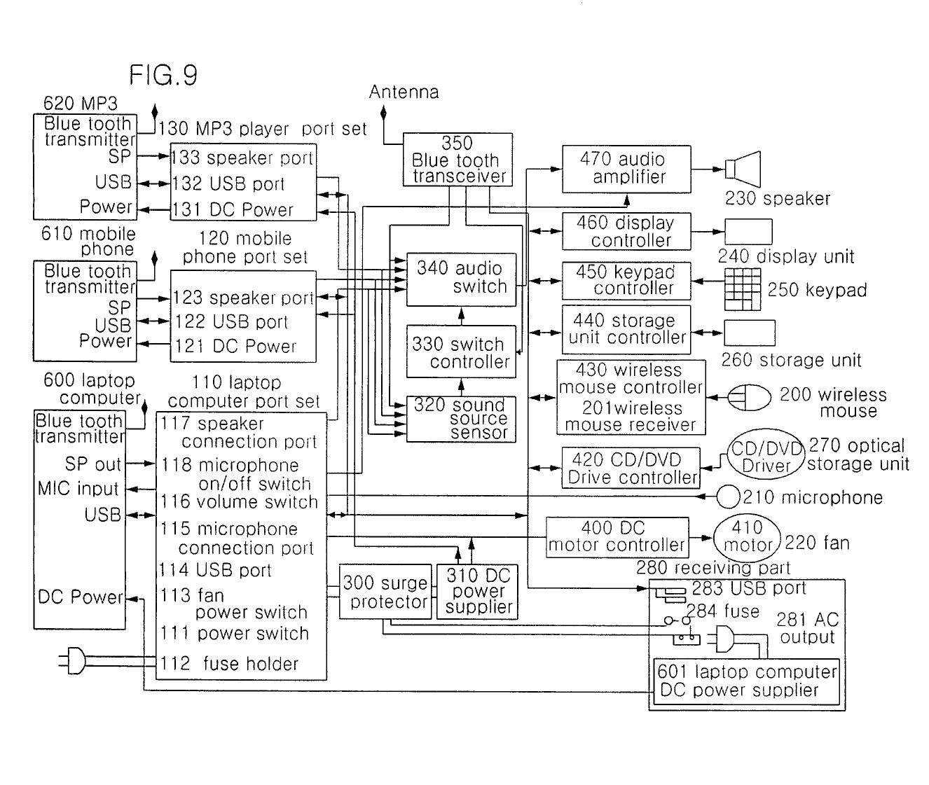

FIG. 9 is a constructional view illustrating the wireless connection between the laptop computer, the MP3 player, and the mobile phone using Blue tooth. As compared to FIG. 4, it can be seen that the laptop computer 600, the mobile phone 610, and the MP3 player 620 each have a Blue tooth receiver for Blue tooth communication, and the intellect station 100 is further provided with a Blue tooth transceiver 350 for short-distance wireless communication with the respective Blue tooth receivers.

The Blue tooth is a communication technology that enables data and voice communication in a wireless fashion within a predetermined distance (for example, 10 meters). When using the Blue tooth, it is possible to accomplish the wireless connection between the mobile phone, the MP3 player, and the laptop computer and the external microphone and the external speakers of the intellect station such that electronic devices can be used in a wireless mode irrespective of the places where the electronic devices are located, for example, offices or homes. Consequently, unlimited communication is possible without the restriction of the user's action or movement caused in a wire mode by providing the Blue tooth receiver for Blue tooth communication to the laptop computer 600, the mobile phone 610, and the MP3 player 620 and further providing the Blue tooth transceiver 350, for short-distance wireless communication with the respective Blue tooth receivers, to the intellect station 100. When the sound source output line of the Blue tooth transceiver 350 is connected to the sound source sensor 320, the sound source sensor 320 detects whether the sound source exists through a Blue tooth-based voice receiving function added to the existing functions. The operation of the switch controller 330 and the audio switch 350 is the same as in the above description, and therefore, a detailed description thereof will not be given to avoid a duplicated explanation.

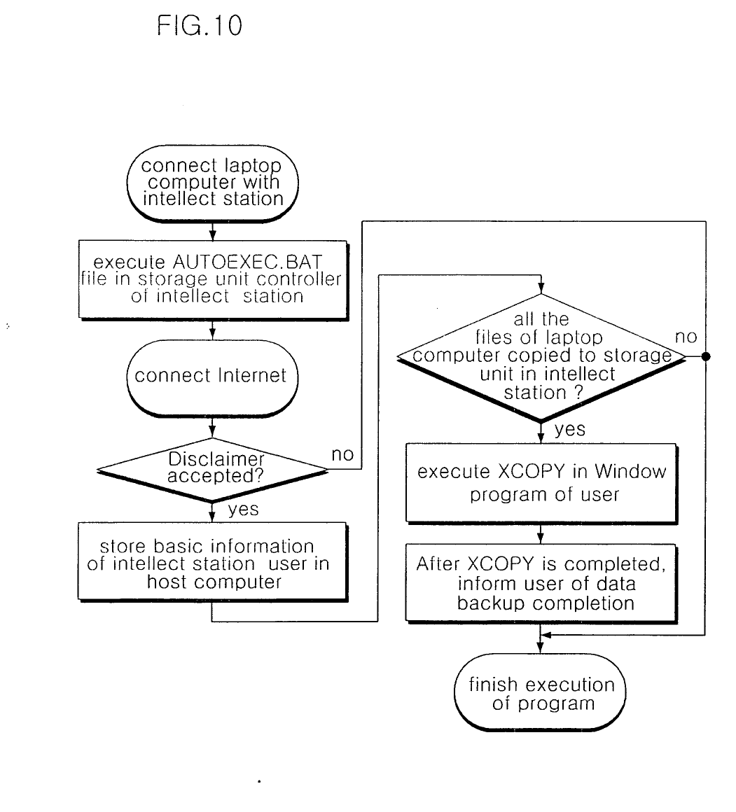

FIG. 10 is a flow chart illustrating an automatic data backup. Referring to FIG. 10, an automatic execution file (AUTOEXEC.bat) is included in the controller of the storage unit 260, such as the hard disk drive (HDD) or the flash memory set, mounted in the intellect station. When the connector connection port of the laptop computer is connected with the docking connector of the intellect station, Internet connection is automatically executed at the laptop computer. When a user accepts disclaimer after the laptop computer is connected to a host computer via Internet, basic information of the user of the intellect station is stored in the host computer. Subsequently, when the user requests that all the files stored in the laptop computer be copied to the storage unit in the intellect station, a command XCOPY (in the directory of C:\windows\command) in a Window operating system (Windows 95, 98, ME, XP) of the laptop computer of the user is executed such that data in the laptop computer is copied to a backup exclusive partition of the storage unit of the intellect station, whereby backup files are created. After that, the user is informed of a data backup completion message or an error message.

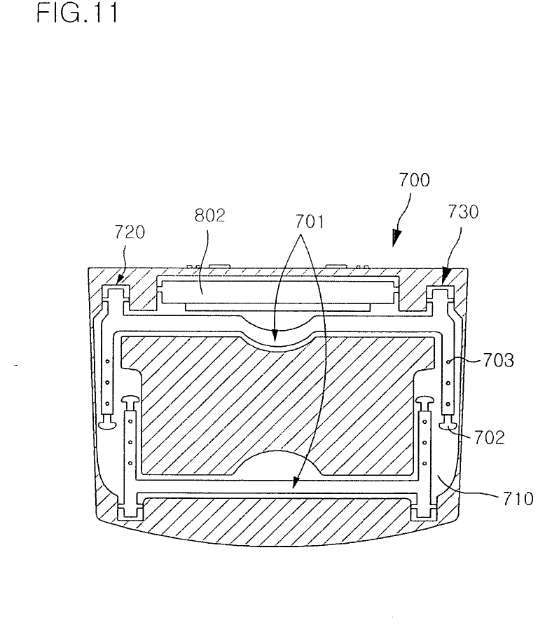

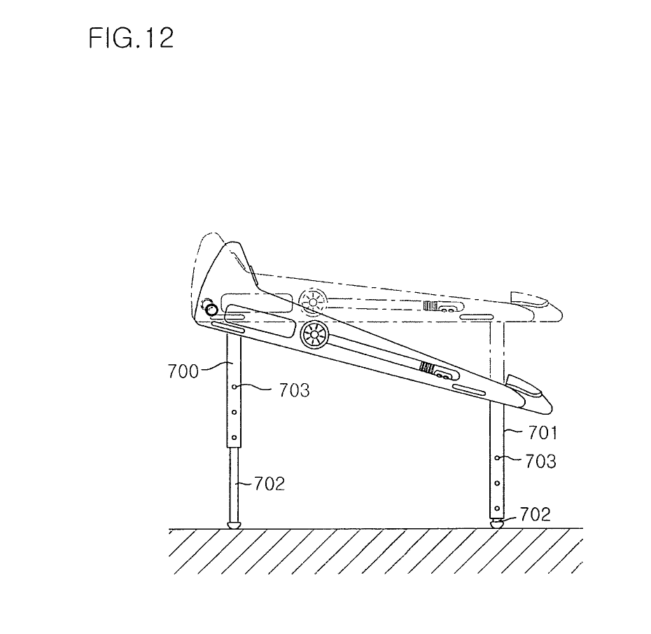

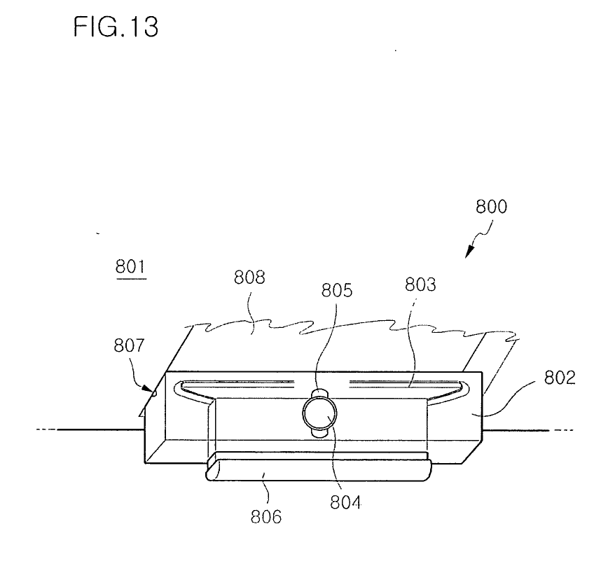

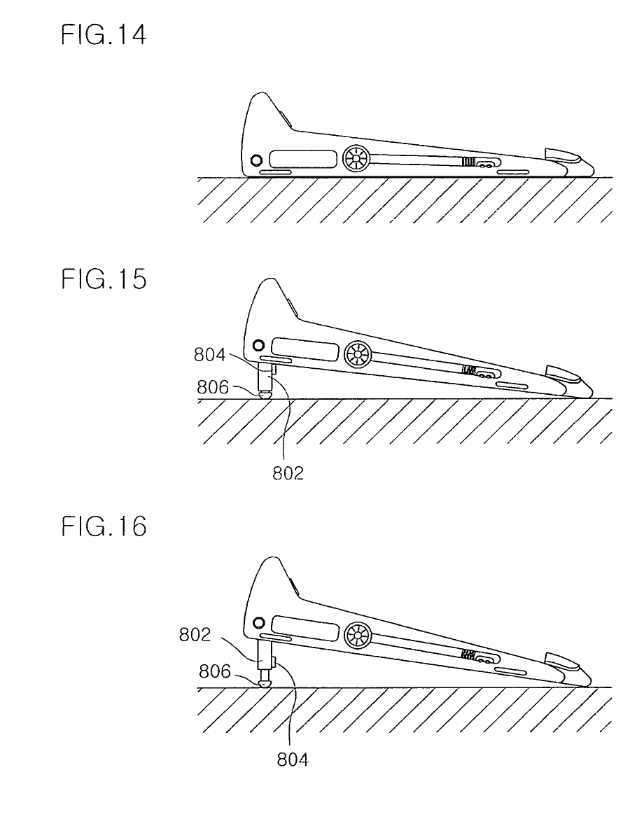

FIG. 11 is a constructional view illustrating a folding leg unit 700 mounted at the bottom of the intellect station according to the present invention, FIG. 12 is a constructional view illustrating unfolding of the folding leg unit 700 shown in FIG. 11 to adjust the height of the folding leg unit 700, FIG. 13 is a constructional view illustrating unfolding of a height adjustment lever shown in FIG. 11, and FIGS. 14 to 16 are side views of the intellect station according to the present invention, illustrating the adjustment of the height of the height adjustment lever shown in FIG. 13. Referring first to FIG. 11, the folding leg unit 700 includes a pair of H-shaped legs 701. The H-shaped legs 701 have different widths. At the bottom of the intellect station, where the H-shaped legs 701 are folded, is formed a depression 710, in which the H-shaped legs 701 are received such that the H-shaped legs 701 do not protrude outward from the bottom of the intellect station. Also, each H-shaped leg 701 has a hollow part, and a height-adjustment auxiliary leg 702 is fitted in the hollow part of each H-shaped leg 701, at the side where the each H-shaped leg 701 is brought into contact with the floor, so as to adjust the height of each H-shaped leg 701. Specifically, a pair of catching protrusions are formed at opposite sides of the upper part of each auxiliary leg 702, and catching holes 703 are formed at the hollow part of each H-shaped leg 701 such that the catching holes 703 are sequentially arranged from the center to the lower end of the hollow part of each H-shaped leg 701. Consequently, the coupling between the auxiliary legs 702 and the H-shaped legs 701 is accomplished by inserting the catching protrusions of the auxiliary legs 702 into the corresponding catching holes 703 of the H-shaped legs 701. Also, a spring (not shown) is mounted in each auxiliary leg 702. Consequently, when the pair of catching protrusions, formed at the upper part of each auxiliary leg 702, are pushed, the catching protrusions are inserted elastically into the each auxiliary leg 702, and therefore, each auxiliary leg 702 can be moved vertically in the hollow part of each H-shaped leg 701. After the vertical movement of each auxiliary leg 702 is completed, the catching protrusions of each auxiliary leg 702 protrude outward through the catching holes 703 of the H-shaped legs 701, whereby the coupling between the auxiliary legs 702 and the H-shaped legs 701 is accomplished. Also, since the depression 710 is formed at the bottom of the intellect station, where the H-shaped legs 701 are folded, as described above, the H-shaped legs 701 do not protrude outward from the bottom of the intellect station while the H-shaped legs 701 are received in the depression 710. The upper ends of the H-shaped legs 701 are mounted to the bottom of the intellect station by hinge members 730. The depression is formed at the inward part of the intellect station such that the H-shaped legs 701 are folded only inward. Also, a stopper 720 is formed at the bottom of the intellect station outside each hinge member 730 to prevent the outward rotation of the H-shaped legs 701.

FIG. 12 is a side view illustrating unfolding of the folding leg unit 700 shown in FIG. 11. The height-adjustment auxiliary legs 702 are inserted into the corresponding hollow parts of the H-shaped legs 701. When the auxiliary legs 702 are withdrawn from the corresponding hollow parts of the H-shaped legs 701, the catching protrusions of the auxiliary legs 702 are inserted into the corresponding catching grooves of the H-shaped legs 701, whereby the coupling between the auxiliary legs 702 and the H-shaped legs 701 is accomplished. Consequently, it is possible for the user to raise or lower the intellect station to a position where the user can conveniently use the intellect station by adjusting the heights of the H-shaped legs 701. Of course, it is also possible for the user to adjust the inclination angle of the incline of the intellect station by differently changing the heights of the respective H-shaped legs 701. In this way, it is possible for the user to adjust the height of the intellect station based on the body size of the user, such that the user can conveniently use the intellect station on his/her lap at a bed or at a sofa, by the provision of the folding leg unit, which is mounted at the bottom of the intellect station such that the height of the folding leg unit can be adjusted.

FIG. 13 is a constructional view illustrating unfolding of a height adjustment lever 800 shown in FIG. 11. The height adjustment lever 800 includes an external lever 802 and an internal lever 806 mounted in the external lever 802. The height adjustment lever 800 is constructed in a structure in which, when the height adjustment lever 800 is inserted in a height adjustment lever insertion groove 808 formed at the bottom 801 of the intellect station inside the H-shaped legs 701 such that the height adjustment lever 800 is received in the height adjustment lever insertion groove 808, the height adjustment lever 800 does not protrude outward from the bottom 801 of the intellect station. At opposite sides of the height adjustment lever insertion groove 808, in which the height adjustment lever 800 is inserted, are formed hinge members 807, to which opposite ends of the external lever 802 are fixed. The height adjustment lever 800 is constructed in a structure in which, when the external lever 802 is rotated by 90 degrees in the counterclockwise direction, further counterclockwise rotation of the external lever 802 is prevented by a stopper (not shown) mounted in the height adjustment lever insertion groove. The internal lever 806 is mounted in the external lever 802. At the top of the internal lever 806 is mounted a leaf spring 803, which urges the internal lever 806 outward. To the internal lever 806 is connected a knob 804. Between the internal lever 806 and the knob 804 is formed a protrusion which is connected to the knob 804 inserted in a catching groove formed in a knob hole 805. Consequently, when the protrusion is inserted into the catching groove of the knob hole 805, the height of the internal lever 806 is fixed. A plurality of catching grooves may be formed in the knob hole 805 such that the height of the intellect station can be differently adjusted according to the interval of the catching grooves.

FIGS. 14 to 16 are side views of the intellect station, illustrating the adjustment of the inclination angle of the intellect station through the adjustment of the height of the internal lever 806. FIGS. 14 to 16 illustrate two-step adjustment of the inclination angle of the intellect station; however, it is possible to adjust the inclination angle of the intellect station more variously by forming a plurality of catching grooves in the knob hole 805.

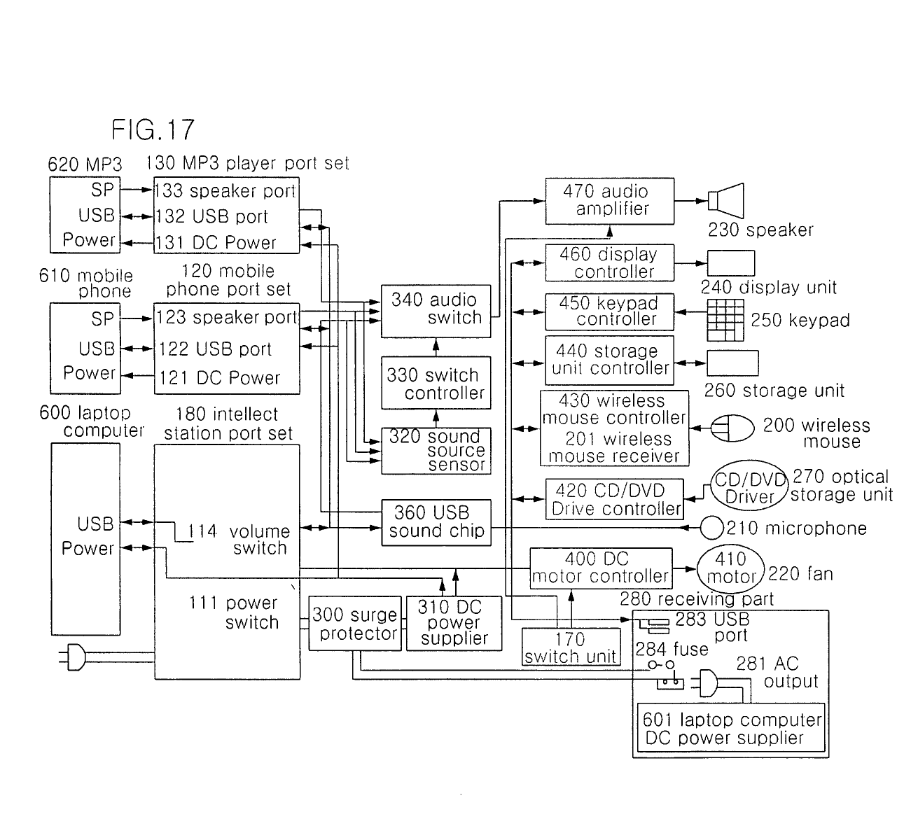

FIG. 17 is a block diagram illustrating another embodiment of the intellect station 100 according to the present invention, using a USB sound chip 360. As shown in FIG. 17, the intellect station 100 has an intellect station port set 180 including a USB port 114, through which an audio signal from the laptop computer 600 is inputted to the intellect station 100, and a power switch 111. The intellect station port set 180 is connected to the laptop computer 600 only via a USB cable. Also, a DC power is supplied to the laptop computer 600 using the USB cable.

The USB sound chip 360 is connected to the intellect station port set 180 and the microphone 210. The USB sound chip 360 converts a voice inputted through the microphone 210 into voice data suitable for the laptop computer 600 and transmits the converted voice data to the laptop computer 600. Also, the USB sound chip 360 converts a voice signal transmitted from the laptop computer 600 into an analog audio signal and transmits the converted analog audio signal to the audio amplifier 470. Also, the USB sound chip 360 converts audio data outputted from the MP3 player into audio data suitable for the laptop computer 600.

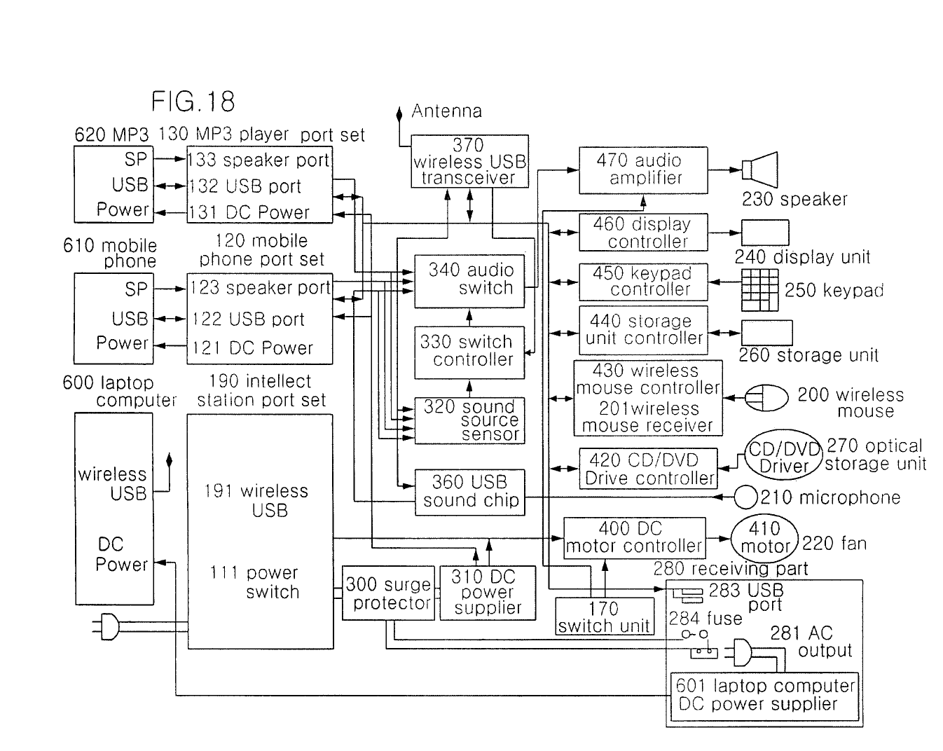

FIG. 18 is a block diagram illustrating another embodiment of FIG. 17, using a wireless USB. As compared to FIG. 17, a wireless USB module is mounted in the laptop computer 600, and a wireless USB adaptor 191 is mounted in an intellect station port set 190.

The intellect station 100 communicates with the wireless USB module of the laptop computer 600 using the wireless USB transceiver 370 in a wireless communication mode. When audio from the laptop computer 600 is received by the intellect station 100, audio processing is carried out by the intellect station 100 through the cooperation of the USB sound chip 360 and the switch controller 330. Consequently, unlimited communication is possible without the restriction of the user's action or movement caused in a wire mode by using the wireless USB.

Except the above-described functions, the functional blocks of FIG. 18 correspond to the functional blocks of FIG. 17, indicated by the same reference numerals, and the functional blocks of FIGS. 17 and 18 have the same operation. Therefore, a detailed description thereof will not be given to avoid a duplicated explanation.

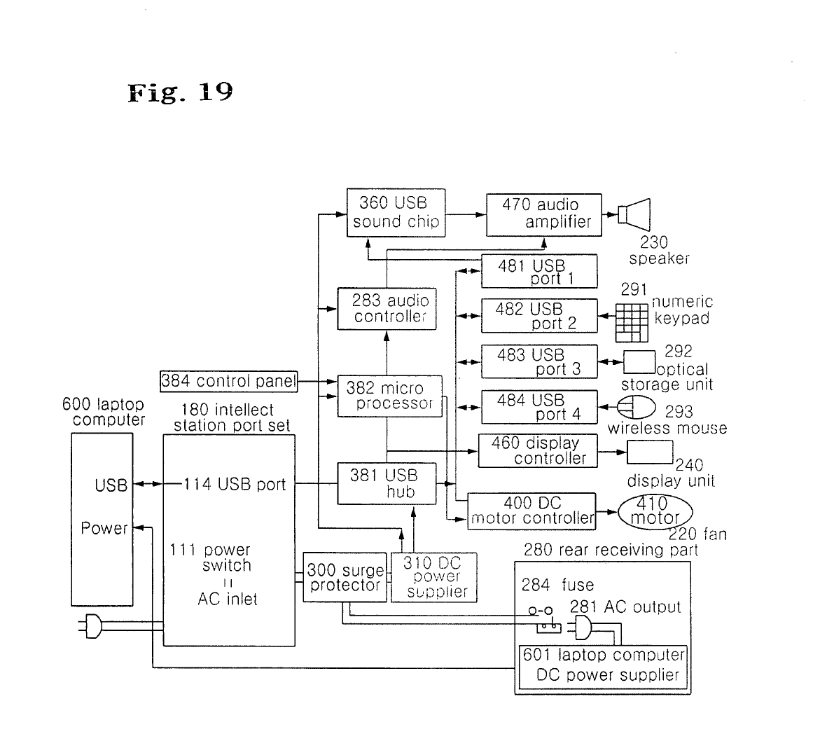

FIG. 19 is a block diagram illustrating another embodiment of the intellect station 100 according to the present invention. In this embodiment, the intellect station 100 is characterized in that a USB hub 381, a microprocessor 382, and a plurality of USB ports (USB port1 to USB port4) 481 to 484 are used, and signals transmitted from external devices each having a controller mounted therein are interfaced in a USB fashion without the provision of a controller for separately processing signals from external devices (a numeric keypad, an optical storage device, a wireless mouse, etc.)

As shown in FIG. 19, the intellect station 100 has a port set 180 including a USB port 114 for interfacing with USB data transmitted from a laptop computer 600 and a power switch 111. Here, the port set 180 is connected to the laptop computer 600 via a single USB cable. The supply of power to the laptop computer 600 is achieved by a DC power supply unit 601 provided at a rear receiving part 280.

Also, the intellect station 100 includes a control panel 384 for providing a signal from control ports provided at the intellect station 100, such as a volume control port for controlling volume in a multi-step fashion, a treble port for controlling treble in a multi-step fashion, a bass port for controlling bass in a multi-step fashion, and a power on/off switch, to a microprocessor 382.

Also, the intellect station 100 further includes a surge protector 300 for clamping excessive voltage, when a surge is introduced into voltage supplied to the intellect station 100 due to thunder and lightning, to protect various electronic components of the intellect station 100 and the laptop computer 600 connected to the intellect station 100 from the surge, and a direct current (DC) power supply unit 310 including a rectifier for rectifying alternating current (AC) voltage of 110 to 220 V, supplied through the surge protector 300, into a DC voltage and a transformer for transforming the DC voltage, rectified by the rectifier, into a predetermined DC voltage, such as DC 3.3V, DC 5V, or DC 12V. By the provision of the surge protector 300 and the DC power supply unit 310, necessary power is stably supplied to the respective parts of the intellect station 100.

Also, the intellect station 100 further includes a display controller 460 for transmitting a signal related to the operation of a USB hub, the level of an audio, and the speed of fans to an LED or LCD display unit.

Also, the intellect station 100 further includes the USB hub 381, which is a USB integrated circuit (IC) for transmitting USB data (audio data) from the laptop computer 600 to the microprocessor 382 through the port set 180. The USB hub 381 is connected to the port set 180, and, at the same time, is connected to the microprocessor 382, the display controller 460, the USB ports 482 to 484 for interfacing with signal from the external devices, and the USB port 481 for interfacing with only audio data. When USB data is transmitted from the laptop computer 600 through the port set 180, the USB hub 381 extracts only control data from the transmitted USB data and transmits the extracted control data to the microprocessor 382. The microprocessor 382 analyzes the transmitted data. When the analyzed data is audio data, the microprocessor 382 controls the volume of an audio amplifier 470 through an audio controller 383, and, at the same time, controls the USB hub 381 to transmit the audio data to a USB sound chip 360 through the USB port 481. The USB sound chip 360 processes the transmitted audio data using a general sound processing fashion, converts the processed audio data into an analog audio signal, and transmits the converted analog audio signal to the audio amplifier 470. The audio amplifier 470 amplifies the transmitted analog audio signal with different gains according to an amplification control signal outputted from the audio controller 383 and transmits the amplified analog audio signal to speakers 230. Consequently, the audio, which is supplied from the laptop computer 600 and amplified, is outputted through the speakers 230. Here, controlling the amplification gain of the audio amplifier 470 is carried out in the same manner as the gain control of a general audio amplifier, and therefore, a detailed description thereof will not be given.

In this embodiment, the speakers 230 are illustrated to be installed at the left and right sides of the intellect station. In addition, it is also possible to install a plurality of woofer speakers at predetermined positions of the intellect station. According to the present invention, the number or the installation positions of the woofer speakers is not particularly restricted so long as the woofer speakers provides an optimum speaker environment that can be provided by a general speaker system.

Also, the microprocessor 382 controls the overall operation of the intellect station 100 such that a controlling operation corresponding to the function inputted through the control panel 384 can be carried out. When a motor controller 400 is operated, the motor controller 400 drives a motor 410 to rotate fans 220 connected to the motor 410. In order to reduce noise generated from the fans, the shape or the number of the fans may be adjusted to control the noise generated from the fans depending upon the amount of blown air. Alternatively, only a signal fan 220 may be provided or the fans 220 may be installed at several positions if necessary.

Also, the intellect station 100 confirms the connection state of the external devices through the USB ports 482 to 484, and appropriately distributes USB data, supplied from the external devices, through the USB hub 381.

The microprocessor 382 analyzes the transmitted data. When the analyzed data is audio data, the microprocessor 382 controls the analyzed data to be outputted to the speakers 230 through the audio amplifier 470.

Also, the intellect station 100 preferably includes a fuse holder 284 for holding a fuse to intercept overvoltage, a power outlet 281, a laptop computer DC power supply unit 601 for supplying power to the laptop computer 600, and a receiving part 280 for receiving various peripheral devices of the laptop computer.

Here, the intellect station 100 is provided with a cover 282 for covering the receiving part 280. At the intellect station 100, on opposite sides of the receiving part 280, are formed fan grills through which air circulated by the fans 220 mounted inside the incline of the intellect station is introduced into or discharged from the intellect station 100.

Meanwhile, the microprocessor 382 confirms whether a voice signal exists in cooperation with the USB hub 381. When it is confirmed that no voice signal exists, the microprocessor 382 automatically performs an audio muting function such that the function of the audio amplifier 470 is interrupted through the audio controller 383. Consequently, it is possible to prevent a signal sound occasionally generated during word processing from being outputted through the speakers 230.

As apparent from the above description, the intellect station, at which the external port set and the power supply units of the laptop computer are integrally formed, is conveniently used while the intellect station is placed on a table or while the intellect station is placed on the lap of a user at a sofa or a bed by unfolding the folding leg unit. Consequently, the present invention has the effect of allowing the user to easily and conveniently use the intellect station without positional restriction and to use the laptop computer in a comfortable posture at a desired place while the user does not need to concern himself/herself with arrangement of the peripheral accessories of the laptop computer or personal belongings, such as an MP3 player and/or a mobile phone.

Also, the power supply unit is mounted at the rear of the intellect station, and therefore, the connection to the power source required to use the laptop computer is easily accomplished irrespective of the location of the laptop computer or electric outlet. Consequently, the present invention has the effect of accomplishing various connections to the external devices.

Also, the plurality of fans are mounted in the incline of the intellect station such that heat generated from the laptop computer is reduced, and therefore, overheating of the laptop computer is prevented. Consequently, the present invention has the effect of enabling the laptop computer to be used for a long period of time.

Also, the sound output from the laptop computer is further increased through the amplifier and speakers mounted in the intellect station. Consequently, the present invention has the effect of enabling the laptop computer to provide quality sound to the user of the laptop computer.

Also, the power cable, the adaptor, and other cables for the laptop computer are neatly received in the receiving part formed at the rear of the intellect station, and the receiving space power supply unit, by which the power cable is connected to the power supply unit, is mounted in the receiving part. As a result, the arrangement of the cables is easily and conveniently accomplished when the laptop computer is used, and no additional power cable for power connection is necessary. Consequently, the present invention has the effect of considerably reducing the number of cables necessary to use the laptop computer.

Also, when the laptop computer is connected to the intellect station, the data stored in the laptop computer can be automatically backed up to the storage unit, such as a hard disk drive or a flash memory set, mounted in the intellect station. Consequently, the present invention has the effect of preventing data loss due to errors.

Meanwhile, the optical storage unit, such as a CD/DVD ROM drive, is mounted in the intellect station. Consequently, the present invention has the effect of allowing a user to conveniently listen to music, watch motion pictures, and install programs.

Also, various additional devices necessary for the laptop computer are provided at the intellect station. Consequently, the present invention has the effect of greatly reducing the weight of the laptop computer and improving the mobility and convenience of the laptop computer.

Also, it is possible for the user of the laptop computer to maintain in a correct posture by the incline of the intellect station. Consequently, the present invention has the effect of preventing the occurrence of spinal injury, a crick in the shoulders, or neck injury. Also, it is possible for the user of the laptop computer to adjust the height and the inclination angle of the intellect station such that the user can maintain a correct posture depending upon the positional change. Consequently, the present invention has the effect of preventing the occurrence of myofascial pain syndrome and turtle neck syndrome causing crick in the neck and shoulders.

Also, it is possible to allow the user of the laptop computer to use the laptop computer, while the wrists and fingers of the user are comfortable, by the provision of the wrist rest formed at the lower end of the incline of the intellect station. Consequently, the present invention has the effect of reducing wrist fatigue and thus preventing the occurrence of carpal tunnel syndrome.

Also, the folding leg unit or the height adjustment lever is mounted at the bottom of the intellect station to adjust the inclination angle of the intellect station based on the physical conditions of the user, and it is possible to conveniently use the laptop computer at a sofa or a bed.

Also, it is possible to use the intellect station or a device(s) coupled to the intellect station at a dark place by the provision of the lamps. In addition, it is possible to provide a light intensity to the user, thereby preventing the lowering of visual power due to low illuminance.

Furthermore, the use of the cable connected between the laptop computer and the intellect station is unnecessary by the application of the wireless USB, and therefore, it is possible to conveniently arrange and use the peripheral accessories.

What is claimed is:

1. An intellect station comprising:
at least one speaker mounted in an inclined protrusion protruding from the upper end of an incline;
a port set and a power supply unit integrally mounted at one side of the incline, the port set and the power supply unit being connected to an external port set and a power supply unit of a laptop computer; and
an MP3 player port set, through which an MP3 player interfaces with the intellect station such that data transmission between the MP3 player and the intellect station is performed, and/or a mobile phone port set, through which a mobile phone interfaces with the intellect station such that data transmission between the mobile phone and the intellect station is performed.

2. The intellect station according to claim 1, wherein the MP3 player port set includes
a speaker port connected to a speaker port of the MP3 player,
a universal serial bus (USB) port connected to a speaker port of the MP3 player, and
a power supply port connected to a power supply port of the MP3 player such that power is supplied to the MP3 player.

3. The intellect station according to claim 1, wherein the mobile phone port set includes
a speaker port connected to a speaker port of the mobile phone,
a USB port connected to a speaker port of the mobile phone, and
a power supply port connected to a power supply port of the mobile phone such that power is supplied to the mobile phone.

4. The intellect station according to claim 1, further comprising:
a surface receiving part formed at the incline such that a numeric keypad is mounted in the surface receiving part, and peripheral devices and a wireless mouse are received in the surface receiving part, wherein
the surface receiving part is provided at the inside thereof with a USB port, a speaker port, and a microphone port, which are connected to a USB port, a speaker port, and a microphone port of the laptop computer, and
the surface receiving part is covered by a cover mounted at the incline.

5. The intellect station according to claim 1, further comprising:
a wrist rest detachably mounted at the lower end of the incline, and
a microphone mounted in the wrist rest or inside the incline blow the wrist rest.

6. The intellect station according to claim 1, further comprising:
one or more fan grills formed at the incline; and
one or more fans mounted in the fan grills, wherein
motors for driving the respective fans and a motor controller for controlling the motor are connected to a fan power switch of the port set.

7. The intellect station according to claim 1, further comprising:
a display controller connected to the port set mounted at the incline for generating a control signal for display; and
a display unit connected to the display controller for displaying functions and data on the screen.

8. The intellect station according to claim 7, further comprising:
a fan power/speed control switch, an audio power/volume switch, a microphone power switch, and at least one on/off switch for turning on/off peripheral devices, such as a hard disk, connected in a USB connection fashion, wherein
the fan power/speed control switch, the audio power/volume switch, the microphone power switch, and the at least one on/off switch are mounted below the display unit.

9. The intellect station according to claim 1, wherein the port set includes at least one selected from a group consisting of a microphone connection port, a speaker/amplifier input port, a USB port, an audio power/volume switch, a fan power/speed control switch, an amplifier power switch, and a power outlet.

10. The intellect station according to claim 1, further comprising:
a sound source sensor connected to output lines of a speaker port of the MP3 player port set and/or a speaker port of the mobile phone port set, and a speaker connection port of the laptop computer port set for detecting which output line the sound source exists on;
a switch controller for analyzing the signal detected by the sound source sensor to determine which output line the sound source exists on and controlling the switch to output the sound source from the corresponding output line to an audio amplifier; and
an audio switch for selecting only one of the output lines of the speaker connection port of the laptop computer port set, the speaker port of the MP3 player port set, and the speaker port of the mobile phone port set in response to the control of the switch controller, and transmitting the sound source from the selected output line to the audio amplifier.

11. The intellect station according to claim 1, further comprising:
a Blue tooth transceiver mounted inside the incline for performing short-distance wireless communication with a Blue tooth receiver mounted in the laptop computer, the mobile phone, and/or the MP3 player.

12. The intellect station according to claim 11, further comprising:
a sound source sensor connected to a sound source output line of the Blue tooth transceiver for detecting whether the sound source exists;
a switch controller for analyzing the signal detected by the sound source sensor to determine which output line the sound source exists on and controlling the switch to output the sound source from the corresponding output line to an audio amplifier; and
an audio switch for selecting only one of the output lines of the speaker connection port of the laptop computer port set, the speaker port of the MP3 player port set, and the speaker port of the mobile phone port set in response to the control of the switch controller, and transmitting the sound source from the selected output line to the audio amplifier.

13. The intellect station according to claim 1, wherein
the intellect station is provided at the incline thereof with a docking connector port including at least one selected from a group consisting of a microphone connection port, a speaker connection port, a USB port, and a power port, and
the docking connector port is connected to a docking station connection port of the laptop computer or the respective ports of the laptop computer via a cable.

14. The intellect station according to claim 1, wherein
the intellect station is provided at the rear thereof with a receiving space for receiving a hard disk or a large-capacity USB flash memory,
the receiving space has a USB port, through which the hard disk is connected, provided therein, and
the receiving space is also provided with a receiving part for receiving a power adaptor, a power outlet, and a power cable of the laptop computer.

15. The intellect station according to claim 14, wherein the receiving part has at least one input and output port including a USB port for data communication and a fuse holder for holding a fuse to intercept overvoltage.

16. The intellect station according to claim 14, further comprising:
fan grills disposed at opposite sides of the receiving part for circulating air.

17. The intellect station according to claim 1, wherein the intellect station is provided at one side thereof with a data storage unit including at least one selected from a group consisting of a hard disk drive, a large-capacity USB flash memory, and a CD/DVD ROM drive.

18. The intellect station according to claim 17, wherein the data storage unit has an automatic executable file included therein, whereby, when the laptop computer is connected to the intellect station, data stored in the laptop computer is automatically backed up to the data storage unit through the connection via Internet.

19. The intellect station according to claim 1, further comprising:
a wireless mouse receiver mounted at the incline.

20. The intellect station according to claim 1, further comprising:
a mouse pad detachably mounted on the incline, or
a mouse board mounted in the intellect station at one side of the intellect station such that the mouse board can be withdrawn from the intellect station.

21. The intellect station according to claim 1, further comprising:
a folding leg unit mounted at the bottom of the intellect station, wherein
the folding leg unit is hingedly connected to the bottom of the intellect station,
stoppers are formed at the bottom of the intellect station outside hinge members for preventing further outward rotation of the folding leg unit after the folding leg unit is unfolded, and
the intellect station is provided at the bottom thereof with a depression, in which the folding leg unit is received such that the folding leg unit does not protrude outward from the bottom of the intellect station.

22. The intellect station according to claim 1, wherein the intellect station is provided at one side thereof with a power supply port to which a power port of a lamp device is connected.

23. The intellect station according to claim 22, wherein
the lamp device is provided at the side opposite to the power port with a rotary roller and a rotary rod that can be rotated by the rotary roller,
the rotary rod is provided at the upper end thereof with a groove, in which lamps are mounted, and
the lamp device is also provided with a bending member, which is formed below the groove.

24. The intellect station according to claim 1, wherein the intellect station is provided at one side thereof with an automatic cable winding switch for driving an automatic cable rewinding device that automatically rewinds a power cable of the intellect station using a leaf spring, and a fuse holder.

25. The intellect station according to claim 1, wherein
a plurality of speakers and woofer speakers are mounted in the inclined protrusion, or
a pair of speakers and woofer speakers are mounted at opposite sides of the inclined protrusion.

26. The intellect station according to claim 1, wherein the external port set includes
a wireless USB module mounted in the laptop computer, and
a wireless USB adaptor for wireless data communication.

27. An intellect station comprising:
a port set for interfacing with USB data transmitted from a laptop computer connected to the intellect station;
a plurality of USB ports for data interfacing with external devices;
a USB hub for setting a channel of USB data transmitted from the laptop computer via the port set and data transmitted from the external devices connected to the USB ports;
a microprocessor for analyzing the data transmitted through the USB hub, and, when the analyzed data is audio data, controlling the USB hub to control the channel of the audio data and controlling the volume of an audio amplifier through an audio controller; and
a USB sound chip for processing the audio data transmitted through the USB ports in a sound processing fashion, converting the processed audio data into an analog audio signal, and transmitting the converted analog audio signal to the audio amplifier.

28. The intellect station according to claim 27, wherein the microprocessor confirms whether a voice signal exists in cooperation with the USB hub, and, when it is confirmed that no voice signal exists, the microprocessor automatically performs an audio muting function such that the function of the audio amplifier is interrupted through the audio controller.

29. The intellect station according to claim 27, further comprising:
a control panel for inputting signals from a plurality of control ports provided at the intellect station;
a surge protector for clamping excessive voltage, when surge is introduced into voltage supplied to the intellect station, to protect various electronic components of the intellect station and the laptop computer connected to the intellect station from the surge;
a direct current (DC) power supply unit for rectifying alternating current (AC) voltage supplied through the surge protector and transforming the rectified voltage into a predetermined DC voltage; and
a motor controller for driving a motor under the control of the microprocessor to operate fans connected to the motor such that heat is dissipated by the fans.

30. The intellect station according to claim 27, further comprising:
a plurality of woofer speakers for increasing bass.
